(19) United States
(12) Patent Application Publication
(10) Pub. No.: US 2020/0285685 A1
(43) Pub. Date: Sep. 10, 2020

(54) SYSTEMS AND METHODS FOR RESEARCH POSTER MANAGEMENT AND DELIVERY

(71) Applicant: Richard Crump, Lowell, MA (US)

(72) Inventor: Richard Crump, Lowell, MA (US)

(21) Appl. No.: 16/813,644

(22) Filed: Mar. 9, 2020

Related U.S. Application Data
(60) Provisional application No. 62/816,141, filed on Mar. 10, 2019.

(51) Int. Cl. G06F 16/9538; G06F 16/955; H04L 29/08; G09B 5/02

(52) U.S. Cl. CPC G06F 16/9538; G06F 16/9554; G09B 5/02; H04L 67/146; H04L 67/141

(57) ABSTRACT

A system of management and delivery of research/scientific posters over a computer network includes a web application for creating a poster session portal, managing poster submissions, allowing presenters to submit posters, and searching a poster repository. The system also includes a server that processes session portal creation requests, session management requests, and poster submission requests. Session portal information and poster meta-data may be stored on a database associated with the system. The system further includes a searchable repository for storing and accessing research/scientific posters, and a research/scientific poster labeling system with a viewing access policy-engine. A research/scientific poster's label may be scanned using a mobile application of the system, and contents of the research/scientific poster may be viewed using the mobile application and/or other applications associated with the system.

### CROSS REFERENCE TO RELATED APPLICATION

This application claims the benefit of and priority to U.S. Provisional Application No. 62/816,141, filed on Mar. 10, 2019 under 35 U.S.C. § 119(e), which application is incorporated by reference herein in its entirety.

### FIELD

This disclosure relates generally to systems and methods for management and delivery of posters, for example, research/scientific posters associated with one or more conference sessions.

### BACKGROUND

In recent years academic, scientific, and industry conference poster sessions have become an important venue for researches, scholars, and students to present pre-published cutting-edge research. It is time consuming for poster event session administrators to organize poster sessions, keep track of submitters and the status of their submissions. Additionally, there is little time for conference goers to see and study the posters. Posters are generally not included in the conference proceedings or archived in on-line repositories. It is difficult for conference goers to collect research presented in posters and for presenters to distribute their posters.

As pointed out by Nicholas Rowe in his book “Academic & Scientific Poster Presentation: A Modern Comprehensive Guide”¹, conference posters are difficult to locate and search using commonly available tools. He additionally reports “a central facility for managing conference materials would help not only in the way it is accessed (inside and outside the event) but also how large volumes of data can be managed”. ¹ Nicholas Rowe, Academic & Scientific Poster Presentation: A Modern Comprehensive Guide, Springer International Publishing, 2017.

### SUMMARY

Described herein are systems and methods related to management and delivery of posters over a computer network. More particularly, in one aspect of this disclosure, a system of management and delivery of posters (e.g., research/scientific posters) over a computer network includes a web application (sometimes simply referred to herein as a “web app”) for creating a poster session portal, managing poster submissions, allowing presenters to submit posters, and searching a poster repository. The system also includes a server that processes session portal creation requests, session management requests, and poster submission requests. Session portal information and poster meta-data are stored on a database associated with the system. The system further includes a searchable repository for storing and accessing research/scientific posters, and a poster labeling system with a viewing access policy-engine. A poster's label may be scanned, for example, using a mobile application (sometimes simply referred to herein as a “mobile app”) of the system, and contents of the poster may be viewed using the mobile application and/or other applications associated with the system. In accordance with some aspects of this disclosure, the labeling system may take the form of a Quick Response (QR) code labeling system, and the poster's label may include or correspond to a QR code. It is understood that other forms of labeling systems and labels are of course possible. For example, while the disclosure is often discussed with reference to QR-codes, it is understood that other means of representing data in a machine-readable form are of course possible. The means of representing data may be visual (e.g., one-dimensional or multi-dimensional barcodes), audio (e.g., voice commands), or a combination thereof.

A method of management and delivery of posters is also provided. In one aspect, the method includes receiving, at an input of a portal server, a request from a client coupled to the portal server, the request relating to at least one function or operation of a poster management and delivery system. In response to the request from the client corresponding to a request to create a poster session portal associated with a conference session, a page containing an administrator portal creation interface may be sent from the portal server to the client. Poster session portal definitions may be received in the administrator portal creation interface, and poster session portal data indicative of the poster session portal definitions may be transmitted from the client to the portal server. The poster session portal data may be processed on the portal server to create the poster session portal, the poster session portal corresponding to a platform for poster submitters to submit poster data associated with posters.

In response to the request from the client corresponding to a request to manage poster session portal join requests associated with the poster session portal, a page containing an administrator portal management interface may be sent from the portal server to the client. The poster session portal join requests may be managed on the administrator portal management interface, and information associated with the management of the poster session portal join requests may be transmitted from the client to the portal server. The information associated with the management of the poster session portal join requests may be stored on a memory device (or memory devices) associated with the portal server, for example.

In some embodiments, managing the poster session portal join requests includes evaluating the poster session portal join request based on one or more criterion, and accepting or rejecting the poster session portal join requests based on the evaluation. The criterion may include, for example, at least one of email address and institution name. In some embodiments, the criterion may be set and modified by an administrator (or administrators) of a poster session portal on the poster management and delivery system. In some embodiments, for the poster session portal join requests that are accepted, additional information associated with the posters associated with the accepted poster session portal join requests may be requested, for example, from poster submitters associated with the posters. The additional information (i.e., poster title and poster abstract) may be received, for example, from one or more input devices, as described further below.

In response to the request from the client corresponding to a request from the poster submitters to submit poster data, or a request to submit additional information associated with posters associated with accepted poster session portal join requests, as discussed above, a page containing a poster submitter interface may be sent from the portal server to the client. In accordance with some embodiments of this disclosure, at least a title and an abstract of a poster for submission may initially be received in the poster submitter interface, and the title and the abstract of the poster may be transmitted from the client to the portal server. The title and the abstract of the poster may be evaluated on the portal server to determine if the title and abstract are acceptable.

The title and abstract of the poster may be received, for example, from one or more input devices. The input devices may include a device (e.g., the client) or devices associated with the poster submitter, for example. In some embodiments, the input devices include at least one of a keyboard and a mouse. Additionally, in some embodiments the input devices include at least one of microphone and an image capture device. In embodiments in which the input devices include a microphone, the poster management and delivery system may be configured to process speech signals received from the poster submitter at an input of the microphone to identify the title and the abstract of the poster (as well as additional poster data in some embodiments). Additionally, in embodiments in which the input devices include an image capture device, and the poster management and delivery system may be configured to process images (e.g., still images or video streams) captured by the image capture device to extract the title and the abstract of the poster (as well as additional poster data in some embodiments).

In accordance with some embodiments of this disclosure, the title and the abstract of the poster are determined to be acceptable if the title and abstract meet one or more criterion. The criterion may include, for example, subject matter of the title and abstract length. In some embodiments, the criterion may be set by an administrator (or administrators) of a poster session portal on the poster management and delivery system.

In some embodiments, in response to determining that the title and abstract are acceptable, additional information (i.e., additional poster data) may be requested from the client relating to the poster. The additional information may include, for example, at least one of: author of the poster, contact information of the author, research sponsor, research advisor, and embargo date. Similar to embodiments discussed above, the additional information may be received, for example, from one or more input devices.

In some embodiments, in response to receiving the additional information, the additional information may be transmitted from the client to the portal server. The additional information may be processed on the portal server to determine if a satisfactory poster submission has been achieved. In response to determining that a satisfactory poster submission has been achieved, the title and the abstract of the poster, and the additional information relating to the poster, may be saved on a memory device associated with the portal server.

In some embodiments, in response to determining that a satisfactory poster submission has been achieved, a poster number may be assigned to the poster, and/or one or more messages may be sent to the client relating to the poster submission. In accordance with some embodiments of this disclosure, the title and the abstract of the poster, and the additional information relating to the poster, are saved as image files. In some embodiments, the image files are transferred from the portal server to an archive server for later access by one or more users of the poster management and delivery system. The one or more users may include, for example, at least one of an administrator, a poster submitter, and a poster viewer

In response to the request from the client corresponding to a request from a poster searcher to search poster data, a page containing an archive server interface may be sent from the portal server to the client. One or more keywords relating to the search may be received in the archive server interface, and the keywords may be provided to an archive server coupled to at least one of the portal server and the client. A memory device (or memory devices) associated With the archive server may be searched for poster data relating to the keywords, and the poster data may be provided to the client. In accordance with some embodiments of this disclosure, the poster data is provided on one or more image files on the memory device(s).

In response to the request from the client corresponding to a request from a poster viewer (e.g., a conference goer) to view one or more posters, a page containing an interface capable of scanning machine-readable data may be sent from the portal server to the client. Select machine-readable data associated with the one or more posters may be scanned using the client, and the select machine-readable data may be processed to view information about the one or more posters on the client. In accordance with some embodiments of this disclosure, the select machine-readable data corresponds to a one-dimensional barcode or a multi-dimensional barcode, such as a QR code. The client, which may correspond to a computing device, such as mobile phone or tablet, for example, may scan the select machine-readable data using at least one image capture device associated with the computing device, for example. In accordance with some embodiments of this disclosure, the select machine-readable data may be provided on the actual physical posters on display at the conference poster session. Additionally, in accordance with some embodiments of this disclosure, the purpose of scanning the select machine-readable data is to enable the retrieval of an digital copy of the poster at a later time. For example, an attendee of a conference session can quickly walk around the conference session and scan posters of interest, and at a later time study the digital copy of the posters.

It will be appreciated that the systems and methods disclosed herein simplify the process of poster submission and management, and enable poster searchers and poster viewers to more easily access information associated with posters the poster searchers and poster viewers may be interested in. For example, in a conference session there may be many posters presented, and with the systems and methods disclosed herein the process of submitting, managing, searching, and viewing information associated these posters may occur more efficiently and effectively, as will be become further apparent from discussions below.

While the systems and methods disclosed herein are often discussed with reference to posters, it is understood that the disclosed systems and methods may also be utilized in other applications. For example, it is contemplated that the disclosed systems and methods may also be applied to other presentation forms. For example, in a multi-day conference, there may be many presentations given, and it may be helpful for attendees to be able to easily find the contents of the presentations they are interested in. The presentations may be audible, visual, or a combination thereof. A visual presentation may be given using Microsoft PowerPoint or a similar tool, for example.

Additional advantages and example uses of the present invention will become further apparent from discussions below.

### BRIEF DESCRIPTION OF THE DRAWINGS

The invention may be understood with reference to the following drawings, which are not necessarily to scale. Also, in the drawings, like reference numerals designate corresponding parts throughout the several views.

FIG. 1 is a block diagram illustrating an example conference room session for which embodiments of this disclosure may be found suitable;

FIG. 1a is a block diagram of an example poster management and delivery system, according to an embodiment of the present invention;

FIG. 2a is a flowchart illustrating example operations/functionality of a poster management and delivery system in accordance with embodiments of this disclosure, for example, the poster management and delivery system of FIG. 1a, for a first example type of client of the poster management and delivery system;

FIG. 2b is a flowchart illustrating example operations/functionality of a poster management and delivery system in accordance with embodiments of this disclosure, for example, the poster management and delivery system of FIG. 1a, for a second example type of client of the poster management and delivery system;

FIG. 2c is a flowchart illustrating example operations/functionality of a poster management and delivery system in accordance with embodiments of this disclosure, for example, the poster management and delivery system of FIG. 1a, for a third example type of client of the poster management and delivery system;

FIG. 2d is a flowchart illustrating example operations/functionality of a poster management and delivery system in accordance with embodiments of this disclosure, for example, the poster management and delivery system of FIG. 1a, for a fourth example type of client of the poster management and delivery system;

FIG. 3 is an example screen representation of an administrator portal creation interface in accordance with embodiments of this disclosure;

FIG. 4 is an example screen representation of an administrator portal management interface in accordance with embodiments of this disclosure;

FIG. 5 is an example screen representation of a submitter portal selection/join interface in accordance with embodiments of this disclosure;

FIG. 6 is an example screen representation of a submitter poster submit interface in accordance with embodiments of this disclosure;

FIG. 7 is an example screen representation of a searcher poster search interface in accordance with embodiments of this disclosure;

FIG. 8 is an example screen representation of a mobile machine-readable data scanning interface for a poster management and delivery system in accordance with embodiments of this disclosure;

FIG. 9 is an example screen representation of a mobile poster-viewing interface of in accordance with embodiments of this disclosure; and

FIG. 10 is a flowchart illustrating example operations/functionality of portal server viewing access policy-engine associated with a poster management and delivery system in accordance with embodiments of this disclosure.

### DETAILED DESCRIPTION

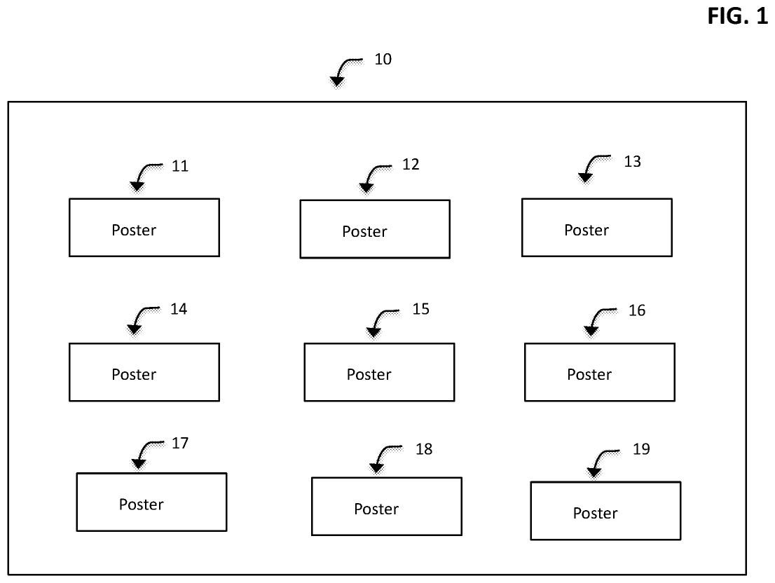

Referring to FIG. 1, as is known, at a conference session 10 one or more posters (here, a plurality of posters 11, 12, 13, 14, 15, 16, 17, 18, 19) may be displayed for conference goers or attendees to view. Often many posters are displayed (i.e., much more than that shown in FIG. 1) and, due to time constraints, for example, it may difficult for the conference goers to spend as much time viewing the posters as the conference goers may like. Additionally, for posters that the conference goers are interested in learning more information about, it can often be time consuming and/or cumbersome for the conference goers to note each author, title, abstract, etc. of the posters, obtain contact information for the authors (i.e., poster submitters or presenters), etc. In some instances, contact information for the authors (e.g., email address), for example, may not even be provided on the posters.

As noted in the Background section of this disclosure, for example, there is a need for more effective poster management and delivery, for example, to enable conference goers to later access posters the conference goers are interested in. Additionally, there is a need for more effective poster management and delivery to enable administrators of a conference session (e.g., 10, shown in FIG. 1) to manage poster submissions, for poster submitters to submit posters, and so forth. The systems and methods disclosed herein seek to address the foregoing needs and many other needs, as will become further apparent from discussions below.

Referring to FIG. 1a, an example poster management and delivery system 100 according to an embodiment of this disclosure is shown. As illustrated in FIG. 1a, the poster management and delivery system 100 includes a portal server 103, an archive server 106, and a client 109, all of which are coupled to a network 112. The portal server 103, which may manage poster session portals and submitted posters, for example, may include, a computer system or other apparatus with similar capability. In particular, the portal server 103 may include a processor circuit with a processor 113 and a memory 116, both of which are coupled to a local interface 119. The local interface 119 may include, for example, a data bus with an accompanying control/address bus, as is generally known by those with ordinary skill in the art.

Various peripheral devices may be coupled to the local interface 119. In particular, peripheral devices may include, for example, a keyboard, keypad, touch pad, touch screen, microphone, scanner, mouse, joystick, or one or more push buttons, etc. The peripheral devices may also include display devices, indicator lights, speakers, etc. Specific display devices may be, for example, cathode ray tubes (CRTs), liquid crystal display screens, gas plasma-based flat panel display, or other types of display devices, etc. For example, the portal server 103 may have a printer 120 attached thereto via the local interface 119.

Similarly, the archive server 106, which may manage the poster archive, for example, may include a computer system or other system with similar capability. In particular, the archive server 106 may include a processor circuit with a processor 123 and a memory 126, both of which are coupled to a local interface 129. The local interface 129 may be, for example, a data bus with an accompanying control/address bus, as is generally known by those with ordinary skill in the art.

The client 109 may also include a computer system or other system with similar capability. For example, the client 109 may include a desktop computer, a laptop computer, a handheld computer, a tablet computer, a smart phone, and/or the like. The client 109 includes a processor circuit with a processor 133 and a memory 136, both of which are coupled to a local interface 139. The local interface 139 may be a data bus with an accompanying control/address bus. The client 109 also includes various output interfaces 143 and input interfaces 146 (referred to as devices in FIG. 1a), through which the client 109 may be connected to various peripheral devices. Such peripheral devices may include a display device 149, a printer 153, a keyboard 156, and a mouse 159. Other peripheral devices that may be employed by the client 109 to receive various user input and/or to provide user output, include those listed above with regard to the portal server 103.

The memories 116,126, and 136 are defined herein as both volatile and non-volatile memory and data storage components. Volatile components are those that do not retain data values upon loss of power. Non-volatile components are those that retain data upon a loss of power. Thus, the memories 116, 126, and 136 may comprise, for example, random access memory (RAM), read-only memory (ROM), hard disk drives, floppy disks accessed via an associated floppy disk drive, compact discs accessed via a compact disc drive, magnetic tape accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, each of the processors 113, 123, and 133 may represent multiple processors and each of the memories 116, 126, and 136 may represent multiple memories that operate in parallel. In such a case, the local interfaces 119, 129, and 139 may be appropriate networks that facilitate communication between any of the multiple processors, between any processor and any one of the memories, or between any two of the memories etc. The processors 113, 123, and 133 may be electrical or optical in nature.

The network 112 includes, for example, the Internet, intranets, wide area networks (WANs), local area networks (LANs), wireless networks, or other suitable networks, etc., or any combination of such networks. The portal server 103, the archive server 106, and the client 109 may be coupled to the network 112 in one of the any number of ways known by those with ordinary skill in the art so as to facilitate data communication to and from the network 112. In this respect, the portal sever 103, the archive server 106, and the client 109 may be linked to the network 112 through various devices such as, for example, network cards, modems, or other such communications devices, etc.

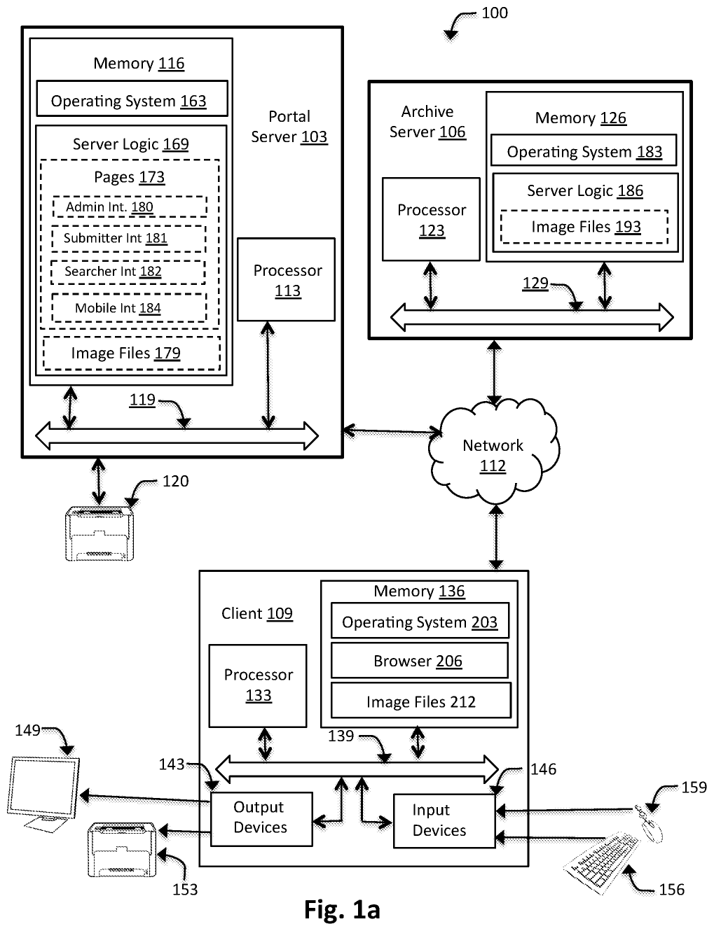

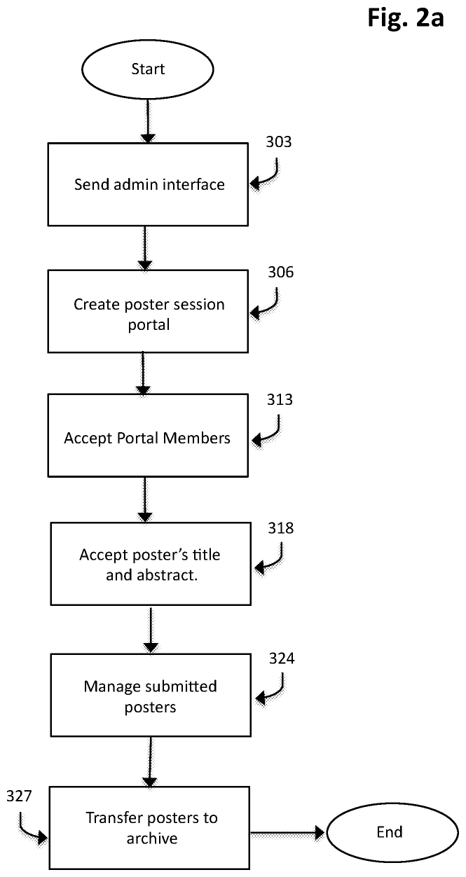

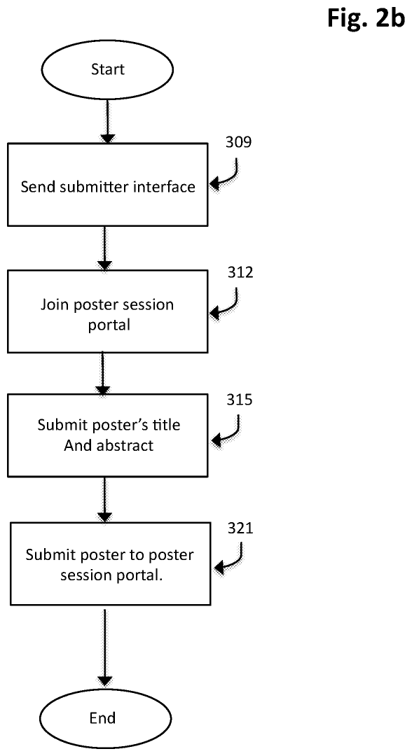

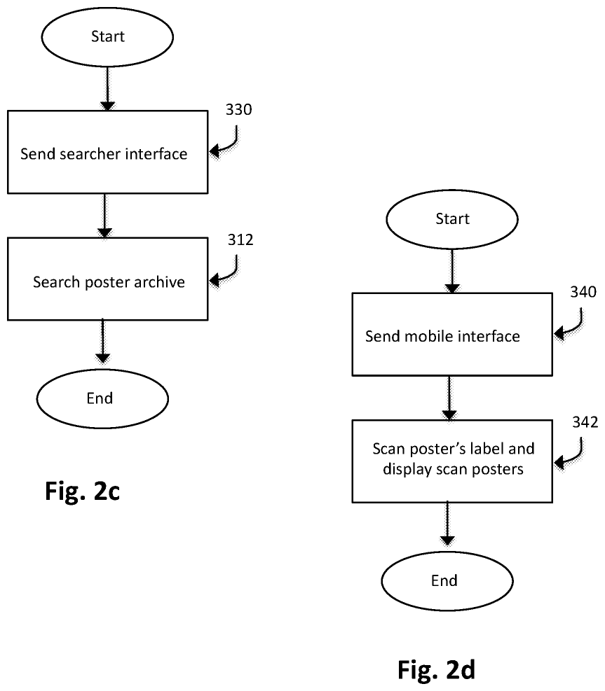

The portal sever 103 includes various software components that are stored on the memory 116 and are executable by the processor 113. These components include an operating system 163 and server logic 169. The server logic 169 may include a network server and may include one or more pages 173 (e.g., HyperText Markup Language (HTML) web pages). In addition, the server logic 169 may include image files 179 including, for example, information associated with research/scientific posters. The information associated may include, for example, static images, interactive images (i.e., a video sequence of images), and/or other relevant data to the research/scientific posters. In one aspect of this disclosure, the image files 179 take the form of PDF files. However, it is understood that other forms of image files 179 are of course possible. In accordance with some embodiments of this disclosure, meta data, such as page size, character fonts used and elements embedded in them such as tables, images, text, etc. may be extracted from the image files 179. Within the pages 173 are user interfaces including administrator interface 180, submitter interface 181, searcher interface 182 and mobile interface 184 that may be used in a poster management and delivery process executed using the poster management and delivery system 100, for example, as discussed further below in connection with FIG. 2a-2d.

The archive server 106 also includes various software components, which are stored on the memory 126 and are executable by the processor 123. These components include operating system 183, as well as server logic 186 that may include image files 193. Image files 193, similar to image files 179, may include information associated with research/scientific posters. The image files 193 may be stored in any of a variety of well-known formats or forms. For example, the image files 193 may be stored in a database so as to be easily identified and retrieved when needed.

It will be appreciated that the functions of the portal server 103 and the archive server 106 may be combined in a single server or may be different servers on a single computer. In accordance with some embodiments of this disclosure, having two servers (i.e., portal server 103 and the archive server 106) introduces a level of security by separating public accessible archive from the private session portals.

The client 109 also includes software components that are stored on the memory 136 and are executable by the processor 133. These components include an operating system 203 and a network browser 206. By manipulating the browser 206, the pages 173 may be downloaded from the portal server 103, having been transmitted by the server logic 169, which is stored on the memory 116 of the portal server 103. Thus, the browser 206 and the server logic 169 may operate, for example, according to the dictates of the Hypertext Transfer Protocol (HTTP) employed on the World Wide Web or other suitable protocol. In this sense, the pages 173 may be created using a markup language, such as hypertext markup language (HTML), as is generally known by those with ordinary skill in the art. Alternatively, other programming languages or formats may be employed to create the pages 173, including extensible markup language (XML) or another mark-up language, JAVA, Active Server Page Scripting (ASP), JAVASCRIPT, C++, or other suitable computer languages and/or formats. It will also be appreciated that that the pages 173 may include other types of pages and/or data files. The memory 136 also may include image files 212.

The operating systems 163, 183, and 203 are executed to control the allocation and usage of hardware resources, such as the memory, processing time and peripheral devices, in the portal server 103, the archive server 106, and the client 109, respectively. In this manner, the operating systems 163, 183, and 203 serve as the foundation on which applications depend as is generally known by those with ordinary skill in the art.

Referring to FIGS. 2a-2d, several flowcharts are shown to illustrate example functionality/operations of a poster management and delivery system (e.g., 100, shown in FIG. 1a) in accordance with embodiments of this disclosure. More particularly, the flowcharts illustrate example functionality/operations of the poster management and delivery system for several examples types of clients (e.g., administrator, submitter, searcher and conference attendee) of the poster management and delivery system. Processing blocks and decision blocks may be provided in the flowcharts. The processing blocks represent computer software and/or algorithm instructions or groups of instructions. Additionally, the decision blocks represent computer software and/or algorithm instructions, or groups of instructions, which affect the execution of the computer software and/or algorithm instructions represented by the processing blocks. The processing blocks and decision blocks (and other blocks shown) can represent steps performed by functionally equivalent circuits such as a digital signal processor circuit or an application specific integrated circuit (ASIC).

The flowcharts do not depict the syntax of any particular programming language. Rather, the flowcharts illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied. Thus, unless otherwise stated, the blocks described below are unordered; meaning that, when possible, the blocks can be performed in any convenient or desirable order including that sequential blocks can be performed simultaneously and vice versa. It will also be understood that various features from the flowcharts described below may be combined in some embodiments. Thus, unless otherwise stated, some features from the flowcharts described below may be combined with other features of the flowcharts described below, for example, to capture the various advantages and aspects of systems and methods associated with research poster management and delivery sought to be protected by this disclosure. It is also understood that various features from the flowcharts described below may be separated in some embodiments. For example, while the flowcharts are shown having many blocks, in some embodiments the illustrated method shown by these flowcharts may include fewer blocks or steps.

With reference now to FIG. 2a, a high-level flowchart is shown, illustrating example functionality (e.g. logical functions) of a poster management and delivery system (e.g., 100, shown in FIG. 1a) in accordance with embodiments of this disclosure. More particularly, in one example implementation, the flowchart of FIG. 2a may represent example method steps taken in operation of the poster management and delivery system, for example, for an administrator client of the poster management and delivery system. The method steps may include steps taken both in a portal server (e.g., 103, shown in FIG. 1a) of the poster management and delivery system, and in downloading (from the portal server to a client, e.g., 109, shown in FIG. 1a, of the poster management and delivery system) and operation of user interfaces (e.g., 180, shown in FIG. 1a) of the poster management and delivery system. In accordance with some embodiments of this disclosure, the user interfaces may be displayed on a display (e.g., 149, shown in FIG. 1a) of the client to allow the user of the client to view and interact with the poster management and delivery process. For simplicity of discussions of the flowchart shown in FIG. 2a, reference will now be made to specific components/portions of the poster management and delivery system 100 shown in FIG. 1a. However, as discussed above in connection with FIG. 1a, it is understood that poster management and delivery system 100 is but one example of poster management and delivery systems in accordance with embodiments of this disclosure, and variations are of course possible.

As illustrated in FIG. 2a, the method begins at block 303, where a page 173 containing an administrator portal creation interface 180 is sent from the portal server 103 to the client 109 in response to a request from the client 109 to create a poster session portal. In accordance with some embodiments of this disclosure, the request is sent from the client 109 to the portal server 103 and the portal server 103 determines if the client 109 is an authorized to create poster portal sessions prior to sending the administrator portal creation interface 180 to the client 109. If it is determined that the client 109 is not authorized to create poster portal sessions (i.e., does not have appropriate access credentials), the portal server 103 may request further information from the client 109. Alternatively, if it is determined that the client 103 is authorized to create poster portal sessions (i.e., has appropriate access credentials), the portal server 103 may send the page 173 containing the administrator portal creation interface 180 to the client 109, and the page 173 may be displayed on a display 149 of the client. It is understood that many means of authentication are possible. In general, the client must have an account and be logged in to the poster management and delivery system. In accordance with some embodiments of this disclosure, idle logins are auto-logged out. Additionally, in accordance with some embodiments of this disclosure, as part of the login process, the client must pick a role (e.g., administrator, submitter, or searcher) and will only be presented with appropriate interfaces. In some embodiments, the client can only edit portals/posters the client has created.

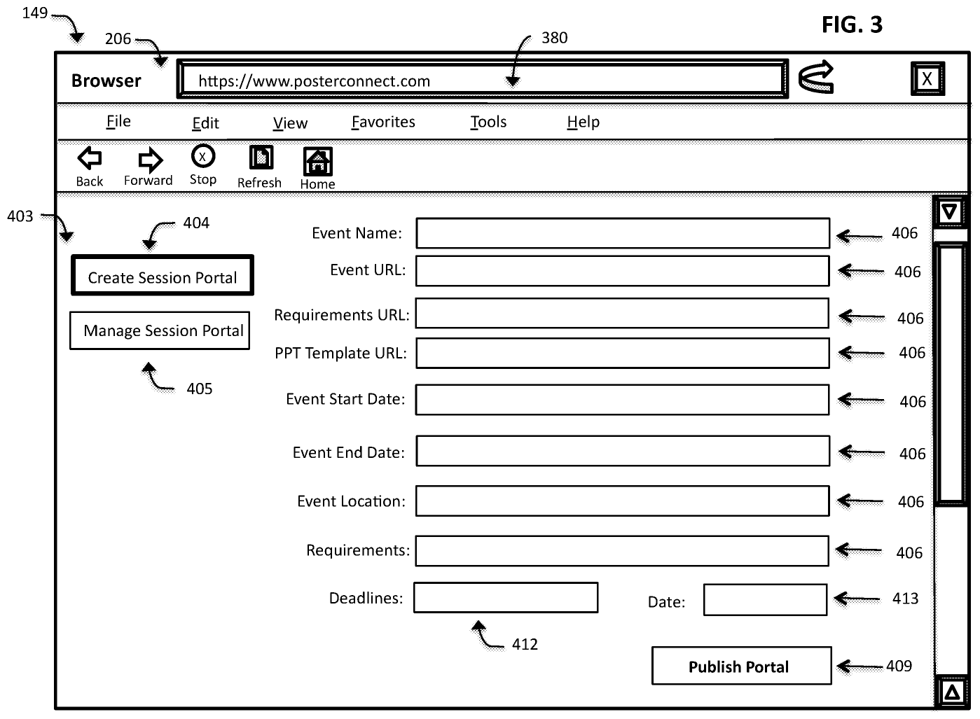

The administrator portal creation interface 180 is configured to allow the user of the client to create a poster session portal at block 306. In one example implementation, the interface 180 allows the user of the client to utilize input devices such as a keyboard 156 and a mouse 159 to input poster session portal definitions. As described further in connection with FIG. 3, the poster session portal definitions may include, for example, event name, URL pointing to event web page, URL pointing to poster requirements web page, URL pointing to poster template file, event start and end dates, event organizer, event location (may include venue name, city, state, and country), poster session names, and requirements (may include profile picture, eMail address, major, institution name, poster size, poster orientation, minimum, maximum abstract length, and poster viewing access policy-engine settings).

It is understood that other types of input devices besides a keyboard and a mouse may additionally or alternatively be used to input the poster session portal definitions. For example, in accordance with some embodiments of this disclosure, a microphone and/or an image capture device may additionally or alternatively be used.

It will be appreciated that the administrator portal creation interface 180, one example of which is shown and discussed further in connection with FIG. 3, for example, may involve multiple pages 173 and/or may involve multiple hierarchical levels of menus, and may involve separate confirmation operations.

In block 306, once the user of the client 109 has populated the poster session portal creation interface 180 to achieve a satisfactory definition of a poster session portal, poster session portal data is uploaded from the client 109 to the portal server 103. Poster session portal data may be saved in portal server 103 memory 116, for example. In accordance with some embodiments of this disclosure, event name, event start date, event end date, event location, and at least one deadline date are needed to achieve a satisfactory definition of a poster session portal. Additionally, in accordance with some embodiments of this disclosure, the poster session portal data includes the required fields to achieve a satisfactory definition of a poster session portal (e.g., event name, event start date, event end date, event location, and at least one deadline date), and one or more of event URL, event organizer, requirements URL, poster sessions names, number of poster sessions, requirements (poster size, abstract length, submitter's email address, submitter's headshot, poster orientation, major, institution name, etc. It is understood that other parameters may additionally or alternatively be required to achieve a satisfactory definition of a poster session portal. It is also understood that other parameters may additionally or alternatively be submitted as poster session portal data.

In block 313, the page 173 containing the administrator portal management interface 180 is sent from the portal server 103 to the client 109 in response to a request from the client 109 to manage poster session portal join requests. Similar to block 303, in accordance with some embodiments of this disclosure, the request is sent from the client 109 to the portal server 103 and the portal server 103 determines if the client 109 is an authorized to manage poster session portal join requests prior to sending the administrator portal management interface 180 to the client 109. If it is determined that the client 109 is not authorized to manage poster session portal join requests (i.e., does not have appropriate access credentials), the portal server 103 may request further information from the client 109.

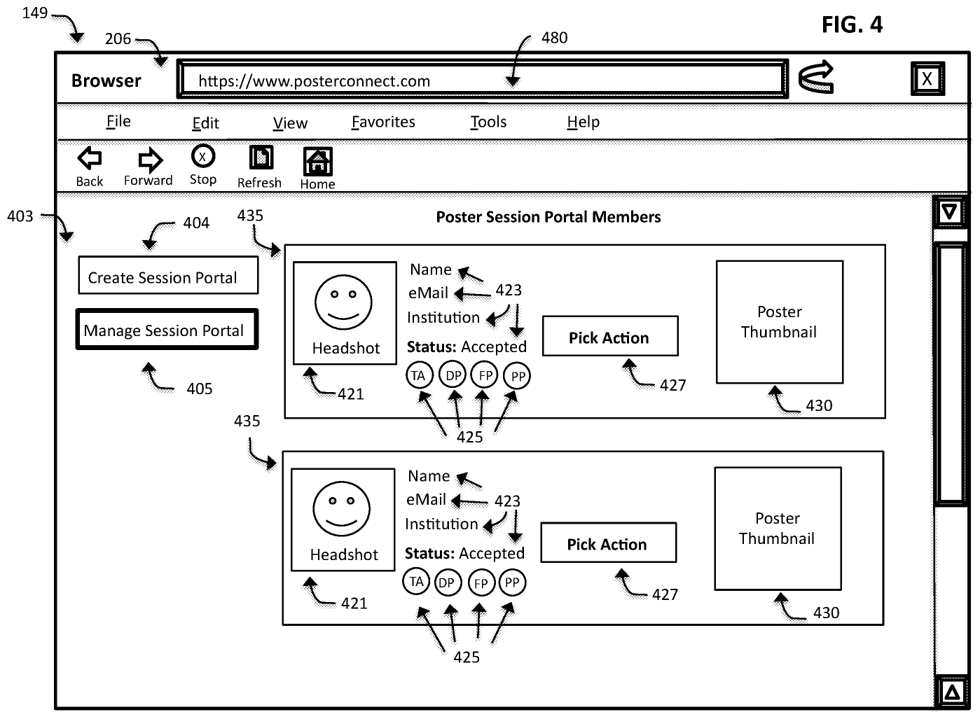

Alternatively, if it is determined that the client 103 is authorized to manage poster session portal join requests (i.e., has appropriate access credentials), the portal server 103 may send the page 173 containing the administrator portal management interface 180 to the client 109, and the page 173 may be displayed on a display 149 of the client 109. The interface 180, one example of which is shown and discussed further in connection with FIG. 4, for example, is configured to allow the user of the client 109 to manage poster session portal join requests. Such management includes accepting or rejecting portal join requests. Membership status may be saved in portal server 103 memory 116, for example.

In block 318, the page 173 containing the administrator portal management interface 180 is sent from the portal server 103 to the client 109 in response to a request from the client 109 to manage poster session portal members. In accordance with some embodiments of this disclosure, the request is sent from the client 109 to the portal server 103 and the portal server 103 determines if the client 109 is an authorized to manage poster session portal members prior to sending the administrator portal interface 180 to the client 109. If it is determined that the client 109 is not authorized to manage poster session portal members (i.e., does not have appropriate access credentials), the portal server 103 may request further information from the client 109. Alternatively, if it is determined that the client 109 is authorized to manage poster session portal members (i.e., has appropriate access credentials), the portal server 103 may send the page 173 containing the administrator portal management interface 180 to the client 109, and the page 173 may be displayed on a display 149 of the client 109. The interface 180 is configured to allow the user of the client 109 to manage poster session portal members. Such management may include editing the poster title and abstract, if needed, then marking the poster title and abstract as accepted or rejected. Poster title and abstract marking may be saved in portal server 103 memory 116, for example.

In accordance with some embodiments of this disclosure, acceptance or rejection of the poster title and abstract is based on an evaluation of the poster title and abstract by the administrator and/or by the system (e.g., software implemented on the system). In some embodiments, in response to determining that the title and abstract are acceptable, additional information (e.g., diagrams, further text) may be requested from the client 109 relating to the poster. In block 324, a page 173 containing the administrator portal management interface 180 is sent from the portal server 103 to the client 109 in response to a request from the client 109 to further manage the poster submission process. Such management may include, for example, sending/receiving messages to/from poster session portal members, tracking that members are meeting poster session deadline dates, assigning submitted poster to specific poster session, assigning poster number to submitted poster, creating a QR-code (or other machine-readable data) for a submitted poster, etc. Additionally, such management may include evaluating additional information (e.g., diagrams, further text) received from the client 109 after acceptance of the poster title and abstract. In accordance with some embodiments, this evaluation (and potentially even block 324) may be optional in embodiments in administrator is accepting all posters for a conference session.

Similar to embodiments discussed above, the page 173 may be displayed on a display 149 of the client 109, and the poster submission process may be further managed using one or more input devices. Additionally, similar to embodiments discussed above, poster assignments, messages, QR-codes (or other machine-readable data), and other data resulting from block 324 may be saved in portal server 103 memory 116, for example.

After a conference poster session associated with a poster session portal session has completed, in block 327, member's poster image files 179 on portal server 103 are transfer to archive server 106 memory 126 as image files 193. In accordance with some embodiments of this disclosure, completion of the conference poster session may be determined, for example, based on an end date of the conference poster session and/or an end date for submitting posters (e.g., in instances where poster submitters unable to attend the conference poster session may still submit posters). These end dates may be determined, for example, based on information received from poster submitters and/or input from an administrator.

It will be appreciated that the administrator portal management interface 180 may involve multiple pages 173 and/or may involve multiple hierarchical levels of menus, and may involve separate confirmation operations.

With reference now to FIG. 2b, a high-level flowchart is shown, illustrating example, functionality (e.g. logical functions) of the poster management and delivery system 100. More particularly, in one example implementation, the flowchart of FIG. 2b may represent example method steps taken in operation of the poster management and delivery system 100, for example, for a poster submitter client of the poster management and delivery system 100. The method steps may include steps taken both in the portal server 103, and in downloading (from the portal server 103 to the client 109) and operation of a poster session portal selection interface 181 (hereinafter, referred to as “portal selection interface” 181 for simplicity) of the poster management and delivery system 100. In accordance with some embodiments of this disclosure, the portal selection interface 181 may be displayed on a display 149 of the client 109 to allow the user of the client 109 to view and interact with the poster management and delivery process.

As illustrated in FIG. 2b, the method begins at block 309, where a page 173 containing a portal selection interface 181 is sent from the portal server 103 to the client 109 in response to a request from the client 109 to join a portal session and submit a poster to the portal. In accordance with some embodiments of this disclosure, the request is sent from the client 109 to the portal server 103 and the portal server 103 determines if the client 109 is authorized to submit a poster prior to sending the portal selection interface 181 to the client 109. If it is determined that the client 109 is not authorized to submit a poster (i.e. does not have appropriate access credentials), the portal server 103 may request further information from the client 109. Alternatively, if it is determined that the client 109 is authorized to submit a poster (i.e. has appropriate access credentials), the portal server 103 may send the page 173 containing the portal selection interface 181 to the client 109, and the page 173, may be displayed on a display 149 of the client. It is understood that many means of authentication are possible. In general, the client must have an account and be logged in to the poster management and delivery system. In accordance with some embodiments of this disclosure, idle logins are auto-logged out. Additionally, in accordance with some embodiments of this disclosure, as part of the login process, the client must pick a role (e.g., administrator, submitter, or searcher) and will only be presented with appropriate interfaces. In some embodiments, the client can only edit portals/posters the client has created.

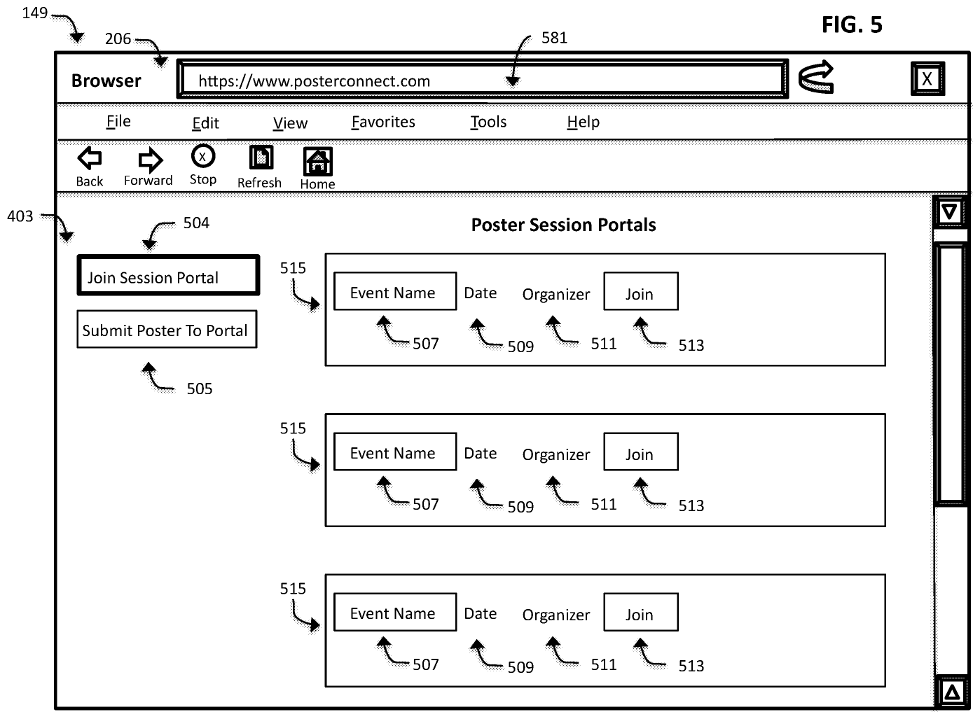

The portal selection interface 181, which may be the same as or similar to portal selection interface 581 shown in FIG. 5, for example, as discussed further below, is configured to allow the user of the client 109 to join a poster session portal at block 309. In one example implementation, the interface 181 allows the user of the client 109 to utilize input devices such as the keyboard 156 and the mouse 159 to select a poster session portal. It will be appreciated that the portal selection interface 181 may involve multiple pages 173 and/or may involve multiple hierarchical levels of menus, and may involve separate confirmation operations.

It is understood that other types of input devices besides a keyboard and a mouse may additionally or alternatively be used to join a poster session portal. For example, in accordance with some embodiments of this disclosure, a microphone and/or an image capture device may additionally or alternatively be used.

In block 312, once the user of the client 109 has selected a poster session portal to join, the poster session portal selection is uploaded from the client 109 to the portal server 103. Poster session portal selection may be saved in portal server 103 memory 116, for example.

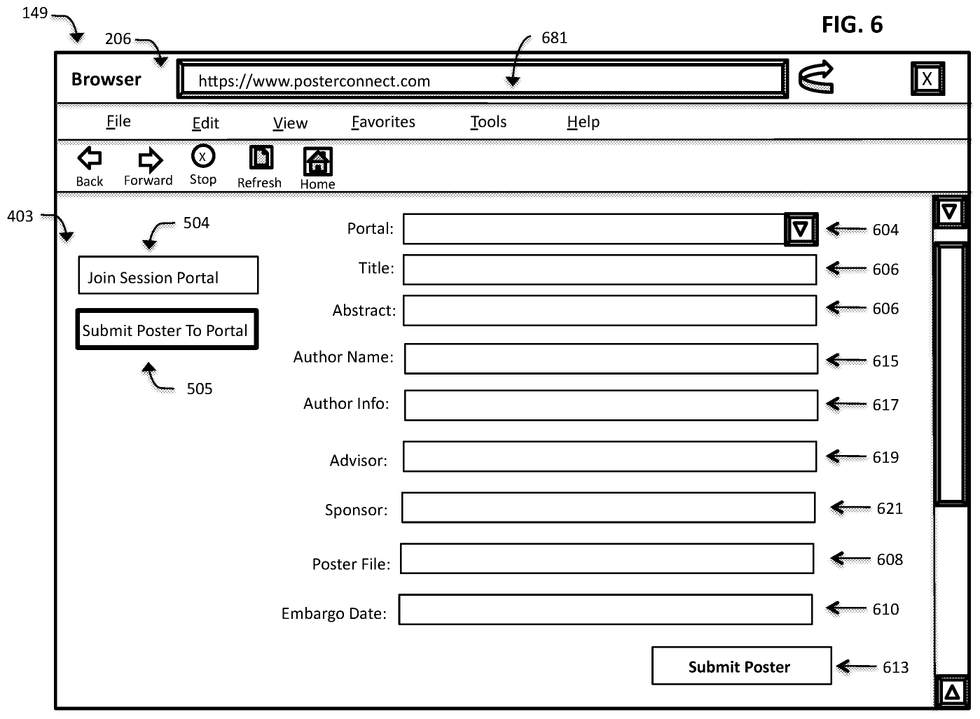

In block 315, the page 173 containing a poster submitter interface 181 is sent from the portal server 103 to the client 109 in response to a request from the client 109 to submit a poster to the poster session portal selected at block 309. Similar to block 309, in accordance with some embodiments of this disclosure, at block 315 the request is sent from the client 109 to the portal server 103 and the portal server 103 determines if the client 109 is an authorized to submit a poster prior to sending the submit poster interface 181 to the client 109. If it is determined that the client 109 is not authorized to submit a poster (i.e., does not have appropriate access credentials), the portal server 103 may request further information from the client 109. Alternatively, if it is determined that the client 103 is authorized to submit a poster (i.e., has appropriate access credentials), the portal server 103 may send the page 173 containing the submit poster interface 181 to the client 109, and the page 173 may be displayed on a display 149 of the client 109. The poster submitter interface 181, one example of which is shown and discussed further in connection with FIG. 6, for example, is configured to allow the user of the client 109 to submit a poster title and abstract (and other poster data, as will be described further below). In one example implementation, the interface 181 allows the user of the client 109 to utilize input devices such as the keyboard 156 and the mouse 159 to enter the poster title and abstract (and other poster data). It will be appreciated that the poster submitter interface 181 may involve multiple pages 173 and/or may involve multiple hierarchical levels of menus, and may involve separate confirmation operations.

Data populating the poster submitter interface 181 may be checked for compatibility with the poster session portal requirements by client 109. Such checking for compatibility is broadly defined as checking for abstract length and/or one or more other criterion (e.g., subject matter of the title). It will be appreciated that some or all of the checking may additionally or alternatively take place at another point in the process, for example, at the portal server 103.

Once the user of the client 109 has entered a poster title and abstract, the poster title and abstract is uploaded from the client 109 to the portal server 103. Poster title and abstract may be saved in portal server 103 memory 116, for example.

After the poster title and abstract has been marked as accepted by the poster session portal administrator (or accepted by the system after an evaluation by the system), in block 321, the page 173 containing the poster submitter interface 181 is sent from the portal server 103 to the client 109 for the client 109 to submit further poster data. For example, in response to determining that the title and abstract are acceptable, a request may be sent from the portal server 103 to the client 109 requesting additional information relating to the poster.

The poster submitter interface 181 is configured to allow the user of the client 109 to submit poster metadata and select one or more poster image files 212. Metadata may include poster authors, authors contact information, research sponsors, research advisor, embargo date, etc. The interface 181 allows the user of the client 109 to utilize input devices such as the keyboard 156 and the mouse 159 to enter poster metadata and select one or more poster image file 212. It will be appreciated that the poster submitter interface 181 may involve multiple pages 173 and/or may involve multiple hierarchical levels of menus, and may involve separate confirmation operations.

Data populating the poster submitter interface 181 may be checked for compatibility with the poster session portal requirements by client 109. Such checking for compatibility is broadly defined as checking for abstract length, image file type, poster orientation, poster size, headshot, eMail address, major, authors, institution name, etc. It will be appreciated that some or all of the checking may additionally or alternatively take place at another point in the process, for example at the portal server 103.

Once the user of the client 109 has populated the poster metadata and has selected one or more poster image files 212 to achieve a satisfactory poster submission, the poster associated with the poster submission may be assigned a poster number and/or one or more messages may be sent to the client relating to the poster submission. Additionally, the poster metadata and the one or more poster image files 212 may be uploaded from the client 109 to the portal server 103. Poster metadata may be saved in portal server 103 memory 116, for example. Additionally, poster image file 212 may be saved in portal server 103 memory 116 as image file 179. In accordance with some embodiments of this disclosure, the poster metadata and/or image file 179 may be transferred from the portal server 103 to an archive server 106 for later access by one or more users of the poster management and delivery system. The one or more users may include, for example, at least one of an administrator, a poster submitter, and a poster viewer, as will be appreciated from further discussions below.

It will be appreciated that the poster submitter interface 181, one example of which is shown and discussed further in connection with FIG. 6, for example, may involve multiple pages 173 and/or may involve multiple hierarchical levels of menus, and may involve separate confirmation operations.

In accordance with some embodiments of this disclosure, one or more portions of the above-discussed method may be automated (or semi-automated). For example, in one example implementation, a microphone (or other speech input means) may receive a speech signal from a user, for example, a poster submitter, and a device (e.g., the client 109 or portal server 103) coupled to the microphone may process the speech signal to identify poster data for submission to a poster management and delivery system in accordance with embodiments of this disclosure. For example, the user may state, “I would like to submit a new poster,” and in response thereto the device may provide instructions to the user for providing the poster data. For example, the device may state, “please provide a title of the poster,” the user may speak the title, and the device may process a speech signal associated with the user's speech to identify the title of the poster. Additionally, the device may state, “please provide an author or authors of the poster,” the user may speak the author(s) name(s), and the device may process a speech signal associated with the user's speech to identify the author(s) name(s), and so forth. The device and the user may continue to have this back and forth interaction until all of the poster data is received (e.g., in the interface 181). It is understood that the speech identification may occur using one or more speech recognition techniques.

In embodiments in which speech recognition/identification techniques are used, it is understood that the user may input additional poster data (e.g., figures or charts) using other means. For example, the user may input the additional poster data using a variety of input devices including, for example, a keyboard, a mouse, and an image capture device.

In another example alternative implementation of the method shown in FIG. 2b, an image capture device may capture information presented on a poster (e.g., automatically and/or in response to user input), and the captured information (e.g., a still image or video stream) may be processed to identify different portions of the poster (i.e., poster data) for submission. For example, the captured information may be processed to identify a title, abstract, author and other portions (e.g., figures) of the poster. The title, abstract, author and other portions of the poster (i.e., poster data) may be identified based on one or more factors including, for example, descriptions, positions, length, font size differences, keywords, etc. of text and figures appearing in the poster.

In one example implementation, the image capture device may be pointed at the poster and the image capture may be initiated in response to user input, for example, through the push of a button (e.g., in the interface 181) or in response to a user gesture (e.g., near the client 109). Additionally, in one example implementation the image capture device may be pointed at the poster and the image capture may be initiated automatically, for example, in response to the image capture device detecting the presence of a poster. The presence of the poster may be detected, for example, based on edge detection techniques or detection of other characteristics of posters (e.g., shape, layout, content, etc.).

In accordance with some embodiments of this disclosure, the image capture device corresponds to a camera (or cameras) of a mobile device, such as a smart phone or tablet, that may be carried by a poster submitter or an administrator, for example. The mobile device may correspond to or be coupled to the client 109, for example. The image capture device may additionally or alternatively correspond to a camera (or cameras) in a facility (or facilities) in which a conference session is held, and/or a camera (or cameras) of a device capable of navigating the facility (or facilities), such as an autonomous device. In accordance with some embodiments of this disclosure, the captured information may be processed locally, for example, on the mobile device, or remotely, for example, on the portal server 103, using one or more image processing and detection algorithms.

The above-discussed image capture embodiment may be desirable, for example, for capturing poster data from posters at a conference session that were not previously submitted to the poster management and delivery system. An administrator, for example, may walk around the facility (or facilities) associated with the conference session and be able to quickly capture poster data from the posters. The captured poster data may be provided to the poster management and delivery system and made accessible to poster searchers and viewers, for example. As another example, an autonomous device or camera(s) in the facility (or facilities) may automatically or selectively capture the poster data (e.g., after determining that the poster data has not been submitted), and provide the poster data to the poster management and delivery system. At a conference session including a significant number of posters, for example, the above-discussed embodiments may save a substantial amount of time.

With reference now to FIG. 2c, a high-level flowchart is shown, illustrating example, functionality (e.g. logical functions) of the poster management and delivery system 100. More particularly, in one example implementation, the flowchart of FIG. 2c may represent example method steps taken in operation of the poster management and delivery system 100, for example, for a poster searcher client of the poster management and delivery system 100. The method steps may include steps taken both in the portal server 103, and in downloading (from the portal server 103 to the client 109) and operation of an archive searcher interface 182 of the poster management and delivery system 100. The archive searcher interface 182 (also sometimes referred to herein as a “poster search interface” 182) may be displayed on a display 149 of the client 109 to allow a user of the client 109 to view and interact with the poster management and delivery process.

As illustrated in FIG. 2c, the method begins at block 330, where a page 173 containing an archive searcher interface 182 is sent from the portal server 103 to the client 109 in response to a request from the client 109 to search a poster archive. In accordance with some embodiments of this disclosure, the request is sent from the client 109 to the portal server 103 and the portal server 103 determines if the client 109 is authorized to search for a poster prior to sending the archive searcher interface 182 to the client 109. If it is determined that the client 109 is not authorized to search for a poster (i.e. does not have appropriate access credentials), the portal server 103 may request further information from the client 109. Alternatively, if it is determined that the client 109 is authorized to search for a poster (i.e. has appropriate access credentials), the portal server 103 may send the page 173 containing the archive searcher interface 182 to the client 109, and the page 173, may be displayed on a display 149 of the client. It is understood that many means of authentication are possible. In general, the client must have an account and be logged in to the poster management and delivery system. In accordance with some embodiments of this disclosure, idle logins are auto-logged out. Additionally, in accordance with some embodiments of this disclosure, as part of the login process, the client must pick a role (e.g., administrator, submitter, or searcher) and will only be presented with appropriate interfaces.

In one example implementation, the archive searcher interface 182 is configured to allow the user of the client 109 to search poster image files 193 on the archive server 106. The interface 182 allows the user of the client 109 to utilize input devices such as the keyboard 156 and the mouse 159 to enter a keyword search string.

It is understood that other types of input devices besides a keyboard and a mouse may additionally or alternatively be used to search the poster archive. For example, in accordance with some embodiments of this disclosure, a microphone and/or an image capture device may additionally or alternatively be used.

In block 312, once the user of the client 109 has entered a keyword search string (or other parameters to search), the search string is sent to the archive server 106. Archive server 106 will search for image files 193 and matching files metadata will be returned to client 109 to be displayed on a display 149 of the client.

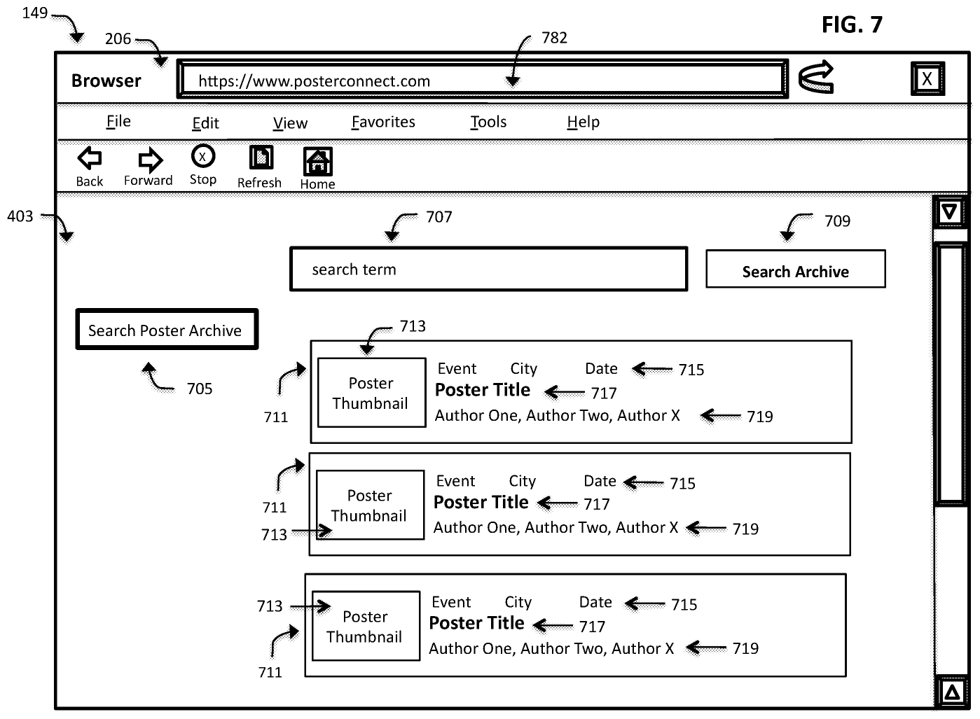

It will be appreciated that the archive searcher interface 182, one example of which is shown and discussed further in connection with FIG. 7, for example, may involve multiple pages 173 and/or may involve multiple hierarchical levels of menus, and may involve separate confirmation operations.

With reference now to FIG. 2d, a high-level flowchart is shown, illustrating example, functionality (e.g. logical functions) of the poster management and delivery system 100. More particularly, in one example implementation, the flowchart of FIG. 2d may represent example method steps taken in operation of the poster management and delivery system 100, for example, for a poster scanning client of the poster management and delivery system 100. The method steps may include steps taken both in the portal server 103, and in downloading (from the portal server 103 to the client 109) and operation of a mobile interface 184 of the poster management and delivery system 100. The mobile interface 184 may be displayed on a display 149 of the client to allow a user of the client 109 (e.g., a conference goer or poster viewer) to view and interact with the poster management and delivery process.

As illustrated in FIG. 2d, the method begins at block 340, where a page 173 containing the mobile interface 184 is sent from the portal server 103 to the client 109 in response to a request from the client 109 to scan a poster's QR-code or other machine-readable data. As noted in connection with figures above, a QR-code or other form of machine-readable data may be provided on posters associated with embodiments of poster management and delivery systems in accordance with embodiments of this disclosure. The QR-code or other form of machine-readable data may be generated on the poster management and delivery system 100, for example, in response to data provided by a poster submitter during the poster submission process. Additionally, the QR-code or other form of machine-readable data may be printed, or etched, etc. and physically coupled to a poster, for example, for scanning by poster scanning clients. Each poster (e.g., 11, 12, etc., shown in FIG. 1) associated with a conference session (e.g., 10, shown in FIG. 1) may have its own unique QR-code or other form of machine-readable data. Moreover, each conference session may have its own set of unique QR-codes or other forms of machine-readable data, for example, in embodiments in which the poster management and delivery system is managing posters associated with a plurality of conference sessions.

Returning now to block 340, in accordance with some embodiments of this disclosure, the request received at block 340 is sent from the client 109 to the portal server 103 and the portal server 103 determines if the client 109 is authorized to scan a poster's QR-code or other machine-readable data prior to sending the mobile interface 184 to the client 109. If it is determined that the client 109 is not authorized to scan a poster's QR-code or other machine-readable data (i.e. does not have appropriate access credentials), the portal server 103 may request further information from the client 109. Alternatively, if it is determined that the client 109 is authorized to scan a poster's QR-code (i.e. has appropriate access credentials), the portal server 103 may send the page 173 containing the mobile interface 184 to the client 109, and the page 173, may be displayed on a display 149 of the client. It is understood that many means of authentication are possible. In general, the client must have an account and be logged in to the poster management and delivery system. In accordance with some embodiments of this disclosure, idle logins are auto-logged out. Additionally, in accordance with some embodiments of this disclosure, as part of the login process, the client must pick a role (e.g., administrator, submitter, or searcher) and will only be presented with appropriate interfaces.

In one example implementation, the interface 184 is configured to allow the user of the client 109 to scan a poster's QR-code or other machine-readable data. The interface 184 allows the user of the client 109 to utilize input devices such as smart phone or tablet.

In block 342, once the user of the client 109 has scanned a poster QR-code or other machine-readable data, the poster QR-code or other machine-readable data is uploaded from the client 109 to the portal server 103. The poster QR-code or other machine-readable data is saved in portal server 103 memory 116. Further, the interface 184 is configured to allow the user of the client 109 to display a list of posters that the user of the client 109 has pervious scanned.

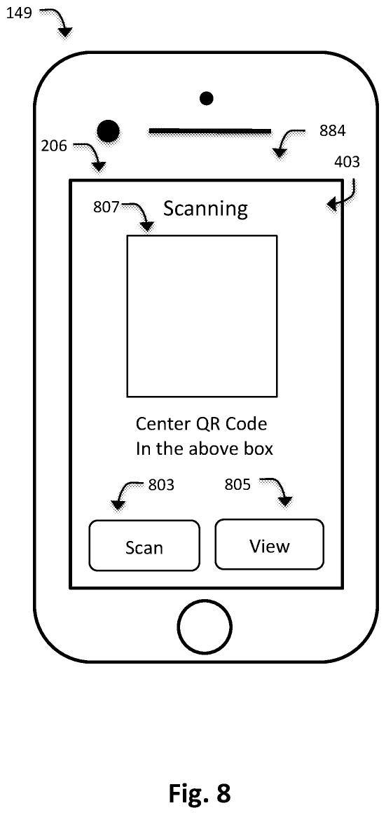

It will be appreciated that the mobile interface 184, one example of which is shown and discussed further in connection with FIG. 8, for example, may involve multiple pages 173 and/or may involve multiple hierarchical levels of menus, and may involve separate confirmation operations.

As illustrated above, and as will be described further below, there are a plurality of types of clients in accordance with embodiments of this disclosure. For example, a researcher client may be shown the search poster archive interface, an administrator client may be shown the portal creation and management interfaces along with the searcher interface, a submitter client may be shown the join portal and submit poster interfaces along with the searcher interface, an attendee may be shown a QR-code machine-readable data scanning and poster list interfaces on a mobile device. Additionally, a web application user can login as any type of client, but one per login (or a set number of logins) in some embodiments. It is understood that a web application could show all interfaces with one login in accordance with some embodiments of this disclosure. It is also understood that the functionality and access rights associated with each of the types of clients may be configured, etc. by a system administrator, for example. Additionally, further types of clients are, of course, possible.

Referring now to FIGS. 3-9, shown are example interfaces in accordance with embodiments of this disclosure. As will be appreciated from discussions below, the illustrated interfaces are but a few of many potential interfaces that may be used in connection with poster management and delivery systems (e.g., 100, shown in FIG. 1a) and methods in accordance with embodiments of this disclosure. As will also be appreciated from discussions below, the various features and elements of the interfaces, including the layouts and configurations of the interfaces, are illustrative only and may be changed, for example, depending on the application (e.g., type of poster conference).

FIG. 3 shows an example administrator poster session portal creation interface 380 (hereinafter, referred to as “portal creation interface” 380 for simplicity) in accordance with embodiments of this disclosure. Similar to interfaces discussed in connection with figures above, portal creation interface 380 may be presented on a display (e.g., 149, shown in FIG. 1a) coupled to a client (e.g., 109, shown in FIG. 1a). As discussed above, portal creation interfaces in accordance with embodiments of this disclosure are configured to allow a user of the client to create a poster session portal. As also noted above, the portal creation interfaces in accordance with embodiments of this disclosure may be part of a page (e.g., 173, shown in FIG. 1a), which may be displayed using a browser (e.g., 206, shown in FIG. 1a).

As illustrated in FIG. 3, the portal creation interface 380 includes a graphical user interface (GUI) 403 having fields 406, 412, and 413 corresponding to poster session details. The fields 406 may be configured to allow the user of the client to enter text regarding the event name, URL pointing to event web page, URL pointing to poster requirements web page, URL pointing to poster template file, event start and end dates, event organizer, event location (may include venue name, city, state, and country), poster session names, and requirements (may include profile picture, eMail address, major, institution name, poster size, poster orientation, minimum abstract length, maximum abstract length, and poster viewing access policy-engine settings). The fields 412 may be configured to allow the user of the client to enter text regarding the name of deadlines coupled with fields 413 to allow the user of the client to enter text regarding the date of deadlines.

It will be appreciated that a mouse (e.g., 159, shown in FIG. 1a) or other pointing device may be used to actuate a text-entering function for the fields 406, 412, and 413. However, many other suitable methods of data entry may be utilized. For example, keyboard commands may be received on a keyboard (e.g., 156, shown in FIG. 1a) coupled to the client and used to navigate between the fields 406, 412, and 413 and to enter data into the fields 406, 412, and 413. Further, many well-known alternatives exist to using fields. For example, pull-down menus and pop-up windows may be utilized, and voice commands may be used to enter data. In embodiments in which voice commands are used, the client may utilize speech recognition software to recognize the voice commands. Speech recognition is well known in the art, and therefore is not described in detail herein.

In accordance with some embodiments of this disclosure, a button 409 may be actuated on the portal creation interface 380 to indicate that the entering of poster session details is complete. The poster session details data may then be communicated from the client to a portal server (e.g., 103, shown in FIG. 1a). Button 404 and button 405 may be actuated to switch the administrator portal interface 380 between it being configured to allow the user of the client to create poster session portal and configured to allow the user of the client to manage poster session portal members.

It will be appreciated that the embodiment of the portal creation interface 380 shown in FIG. 3 and described above is only an example of the range of possible GUI interfaces that may suitably be employed. For example, it will be appreciated that portal creation interface 380 may be configured to allow multiple deadlines 412 with multiple dates 413. Additionally, it will be appreciated that while the portal creation interface 380 is described as having a button 409 to indicate completion of poster session detail entry, and buttons 404, 405 to switch functionality of the portal creation interface 380, other means of indicating completion of poster session detail entry and switching functionality are of course possible. For example, images, check boxes, text fields (e.g., to enter “done” or “finish”), automatic submittal when all fields are filled out, and anchor text may be used to initiate actions and switching functionality.

FIG. 4 shows an example administrator poster session portal members management interface 480 (hereinafter, referred to as “portal members management interface” 480 for simplicity) in accordance with embodiments of this disclosure. Similar to interfaces discussed in connection with figures above, portal members management interface 480 may be presented on a display (e.g., 149, shown in FIG. 1a) coupled to a client (e.g., 109, shown in FIG. 1a). As noted above, portal members management interfaces in accordance with embodiments of this disclosure are configured to allow a user of the client to manage poster session portal members. As also noted above, portal members management interfaces in accordance with embodiments of this disclosure may be part of a page (e.g., 173, shown in FIG. 1a), which may be displayed using a browser (e.g., 206, shown in FIG. 1a).

As illustrated in FIG. 4, the portal members management interface 480 includes a GUI 403 having element 435 corresponding to poster session portal member. The elements 435 may be configured to allow the user of the client to display information regarding the poster session portal members. Information may include, along with other related information, member's headshot 421, poster thumbnail 430, basic member information 423 (name, email address, institution name, membership status, etc.), and status indicators for multiple deadlines 425. It will also be appreciated that that additional member information 423 may include other types of information such as Open Researcher and Contributor ID (ORCID), major, department, laboratory, center, address, phone number, twitter name, LinkedIn name, Facebook name, personal website, etc. The status indications 425 may be configured to show the current state of the deadline (e.g., 412, shown if FIG. 3) as it relates to the poster session portal member by color encoding. A different color may be used, for example, to indicate a different state, such as light green for deadline 412 item submitted, yellow for deadline 412 item coming due, red for deadline 412 item missed, dark green for deadline 412 item accepted, purple for deadline 412 item rejected, etc. In addition, status indications 425 may be labeled by combining the first letter of the first two words of the deadline name 412 together.

Further, elements 435 may be configured to allow the user of the client to initiate actions to manage the poster session portal members by actuating button 427. Actions include, along with other related actions, accepting poster session portal membership request, rejecting of poster session portal membership request, sending messages to poster session portal member, change state of deadline 412 items by accepting or rejecting the item, move poster session portal member's poster from a portal server (e.g., 103, shown in FIG. 1a) to an archive server (e.g., 106, shown in FIG. 1a), export of portal members data and poster data in a machine-readable format (e.g., XML file, JSON string, etc.) or/and human-readable format (e.g., Microsoft Word file, plain text file, etc.), etc. The action details may be communicated from the client to the portal server.

Button 404 and button 405 may be actuated to switch the administrator portal interface 480 between it being configured to allow the user of the client to create poster session portal and configured to allow the user of the client to manage poster session portal members.

It will be appreciated that embodiment of the portal members management interface 480 shown in FIG. 4 and described above is only an example of the range of possible GUI interfaces that may suitably be employed. Additionally, it will be appreciated that while the portal members management interface 480 is described as having a button 427 to initiate actions to manage poster session portal members, and buttons 404, 405 to switch functionality of the portal members management interface 480, other means of initiating actions and switching functionality are of course possible. For example, images, check boxes, text fields (e.g., to enter “done” or “finish”), automatic submittal when all fields are filled out, and anchor text may be used to initiate actions and switching functionality.

FIG. 5 shows an example submitter poster session portal selection interface 581 (hereinafter, referred to as “portal selection interface” 581 for simplicity) in accordance with embodiments of this disclosure. Similar to interfaces discussed in connection with figures above, portal selection interface 581 may be presented on a display (e.g., 149, shown in FIG. 1a) coupled to a client (e.g., 109, shown in FIG. 1a). As discussed above, portal selection interfaces in accordance with embodiments of this disclosure are configured to allow a user of the client to select a poster session portal. As also noted above, portal selection interfaces in accordance with embodiments of this disclosure may be part of a page (e.g., 173, shown in FIG. 1a), which may be displayed using a browser (e.g., 206, shown in FIG. 1a).

As illustrated in FIG. 5, the portal selection interface 581 includes a GUI 403 having elements 515 corresponding to poster session portals. The elements 515 may be configured to allow the user of the client to display information regarding the poster session portals. Information may include event name button 507, event date 509, event organizer 511, and join poster session portal button 513, for example. It will also be appreciated that that additional poster session portal information may be included in element 515.

The user of the client may actuate event name button 507 to display poster session portal details on a display that is coupled to the client. The poster session portal details may be communicated from portal server to the client.

The user of the client may indicate a poster session portal membership request by actuating the join button 513. The request details may be communicated from the client to the portal server.

Button 504 and button 505 may be actuated to switch the portal selection interface 581 between it being configured to allow the user of the client 109 to select poster session portal and configured to allow the user of the client 109 to submit a poster to a poster session portal.

It will be appreciated that the embodiment of the portal selection interface 581 shown in FIG. 5 and described above is only an example of the range of possible GUI interfaces that may suitably be employed. Additionally, it will be appreciated that while the portal selection interface 581 is described as having various buttons to perform a variety of functions, other means of performing the functions are of course possible. For example, images, check boxes, text fields (e.g., to enter “done” or “finish”), automatic submittal when all fields are filled out, and anchor text may be used to perform these functions and other contemplated functions.

FIG. 6 shows an example submitter portal poster submitting interface 681 (hereinafter, referred to as “poster submitting interface” 681 for simplicity) in accordance with embodiments of this disclosure. Similar to interfaces discussed in connection with figures above, poster submitting interface 681 may be presented on a display (e.g., 149, shown in FIG. 1a) coupled to a client (e.g., 109, shown in FIG. 1a). As discussed above, poster submitting interfaces in accordance with embodiments of this disclosure are configured to allow a user of the client to submit a poster to a poster session portal. As also noted above, poster submitting interfaces in accordance with embodiments of this disclosure may be part of a page (e.g., 173, shown in FIG. 1a), which is displayed using a browser (e.g., 206, shown in FIG. 1a).

As illustrated in FIG. 6, the poster submitting interface 681 includes a GUI 403 having fields 604, 606, 615, 617, 619, 621, 608, and 610 corresponding to poster meta data and poster details. The fields 606, 615, 617, 619, 621, and 610 may be configured to allow the user of the client to enter text regarding the poster title, abstract, author name, author information (ORCID, email, major, department, laboratory, center, institution, etc.), research advisor (name and email), research sponsor and embargo date. It will be appreciated that multiple author names 615, author information 617, research advisor 619, and research sponsor 621 may also be entered.

In the illustrated embodiment, a pull-down menu 604 allows a user of the client to make a selection from the available poster session portals for which the user has requested a poster session portal membership and has been accepted.

The field 608 may be configured to allow the user of the client to enter text regarding the location of the poster image file 212. The text may be a path corresponding to the location of a poster image file 212 on the client, for example. It will be appreciated that a mouse or other pointing device may be used to actuate a text-entering function for the field 608. However, many other suitable methods of data entry and/or file selection may be utilized. In accordance with some embodiments of this disclosure, the poster submitting interface 681 may be configured to utilize a browsing function, for example, allowing the user of the client to browse the poster image files 212 located on the client.

Embargo date 610 indicates the user of the client poster should be kept private. After the embargo date 610 has past, a general public user of the client can view the poster and its associated contents.

A button 613 may be actuated to indicate that the entering of poster meta data and poster details is complete. The poster meta data and poster details may be communicated from the client to a portal server (e.g., 103, shown in FIG. 1a). The poster image file 212 may be transferred from the client to the portal server and saved as an image file or image files (e.g., 179, shown in FIG. 1a).

Button 504 and button 505 may be actuated to switch the poster submitting interface 681 between it being configured to allow the user of the client to select a poster session portal and configured to allow the user of the client 109 to submit a poster to a poster session portal.

It will be appreciated that the embodiment of the poster submitting interface 681 shown in FIG. 6 and described above is only an example of the range of possible GUI interfaces that may suitably be employed. Additionally, it will be appreciated that while the poster submitting interface 681 is described as having various buttons and pull-down menus to perform a variety of functions, other means of performing the functions are of course possible. For example, images, check boxes, text fields (e.g., to enter “done” or “finish”), automatic submittal when all fields are filled out, and anchor text may be used to perform these functions and other contemplated functions.

FIG. 7 shows an example searcher poster search interface 782 (hereinafter, referred to as “poster search interface” 782 for simplicity) in accordance with embodiments of this disclosure. Similar to interfaces discussed in connection with figures above, poster search interface 782 may be presented on a display (e.g., 149, shown in FIG. 1a) coupled to the client (e.g., 109, shown in FIG. 1a). As discussed above, poster search interfaces (also sometimes referred to herein as “archive searcher interfaces”) in accordance with embodiments of this disclosure are configured to allow a user of the client to search posters on an archive server (e.g., 106, shown in FIG. 1a). As also noted above, the poster search interfaces may be part of a page (e.g., 173, shown in FIG. 1a), which may be displayed using a browser (e.g., 206, shown in FIG. 1a).

As illustrated in FIG. 7, the poster search interface 782 includes a GUI 403 having a field 707 and a button 709.

The field 707 may be configured to allow the user of the client to enter text regarding a search term or query string to be use in searching image files (e.g., 193, shown in FIG. 1a) on the archive server.

A button 709 may be actuated to indicate that the entering of poster search term and/or query string 707 is complete. The poster search term and/or query string 707 may be communicated from the client to an archive server. The archive server will search image files to locate image files matching the poster search term and/or query string 707. The resulting set of matching files, associated contents, and meta data may be transferred from the archive server to the client as part of a page, which may be present as elements 711 in a browser (e.g., 206, shown in FIG. 1a).

The search results may be display as elements 711 having a poster thumbnail 713, line 715 displaying the event name, event city and event date, line 717 displaying the poster title, and line 719 displaying poster authors. It will be appreciated that other poster meta data and poster details may be included in element 711.

Poster thumbnail 713 may be actuated to transfer a full size poster image file (e.g. 193, shown in FIG. 1a) from the archive server to the client, if the poster embargo date 610 has expired. The poster image file may be part of a page (e.g., 173, shown in FIG. 1a), which may be displayed using a browser (e.g., 206, shown in FIG. 1a).

It will be appreciated that the embodiment of the poster search interface 782 shown in FIG. 7 and described above is only an example of the range of possible GUI interfaces that may suitably be employed. Additionally, it will be appreciated that while the poster search interface 782 is described as having various buttons to perform a variety of functions, other means of performing the functions are of course possible. For example, images, check boxes, text fields (e.g., to enter “done” or “finish”), automatic submittal when all fields are filled out, and anchor text may be used to perform these functions and other contemplated functions.

FIG. 8 show's an example poster session portal mobile scanning interface 884 (hereinafter, referred to as “mobile scanning interface” 884 for simplicity) in accordance with embodiments of this disclosure. Similar to interfaces discussed in connection with figures above, mobile scanning interface 884 may be presented on the display (e.g., 149, shown in FIG. 1a) that is coupled to the client (e.g., 109, shown in FIG. 1a). As discussed above, mobile scanning interfaces in accordance with embodiments of this disclosure are configured to allow the user of the client to scan a poster's QR-code at a conference poster session utilize input devices such as smart phone or tablet. As also noted above, the mobile scanning interface may be part of a page (e.g., 173, shown in FIG. 1a), which may be displayed using a browser (e.g., 206, shown in FIG. 1a).

As illustrated in FIG. 8, the mobile scanning interface 884 includes a GUI 403 having a field 807, button 803, and button 805.

The user of the client may point an input device, such as smart phone or tablet, at a conference poster so as to show the poster's QR-code or other machine-readable data in field 807. Button 803 may be actuated to scan the poster QR-code or other machine-readable data shown in field 807. The QR-code or other machine-readable data shown in field 807 may be transferred from the client to a portal server (e.g., 103, shown in FIG. 1a) and saved in memory (e.g., 116, shown in FIG. 1a).

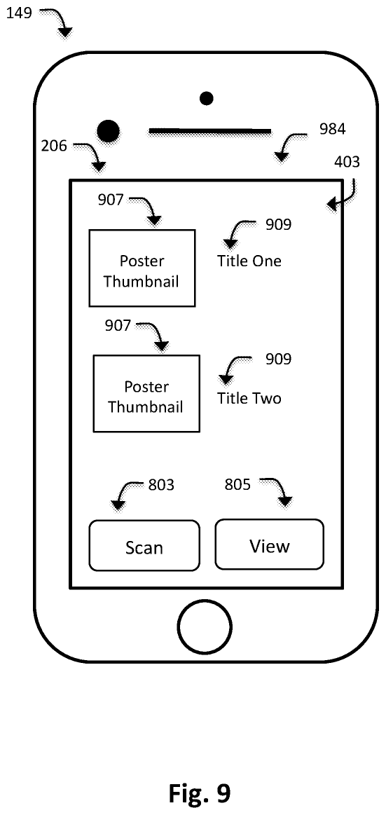

Button 805 may be actuated to switch the mobile scanning interface 884 to be configured to allow the user of the client to display a list of posters that the user of the client has pervious scanned using a smart phone or tablet as shown in FIG. 9.

It will be appreciated that the embodiment of the mobile scanning interface 884 shown in FIG. 8 and described above is only an example of the range of possible GUI interfaces that may suitably be employed. Additionally, it will be appreciated that while the mobile scanning interface 884 is described as having various buttons to perform a variety of functions, other means of performing the functions are of course possible. For example, images, check boxes, text fields (e.g., to enter “done” or “finish”), automatic submittal when all fields are filled out, and anchor text may be used to perform these functions and other contemplated functions.

FIG. 9 shows an example poster session portal mobile list interface 984 (hereinafter, referred to as “mobile list interface” 984 for simplicity) in accordance with embodiments of this disclosure. Similar to interfaces discussed in connection with figures above, mobile list interface 984 may be presented on a display (e.g., 149, shown in FIG. 1a) coupled to client (e.g., 109, shown in FIG. 1a). As discussed above, mobile list interfaces in accordance with embodiments of this disclosure are configured to allow the user of the client to display a list of posters that the user of the client has pervious scanned. As also noted above, the mobile list interfaces may be part of a page (e.g., 173, shown in FIG. 1a), which may be displayed using a browser (e.g., 206, shown in FIG. 1a).

As illustrated in FIG. 9, the mobile list interface 984 includes a GUI 403 having multiple pairs of field 907 and field 909, each pair represents one conference session poster. Additionally, the GUI has button 803 and button 805.

Field 909 may be configured to display a poster title of a poster that had its QR-code or other machine-readable data previously scanned by a user of the client.

Poster thumbnail 907 may be configured to display a poster thumbnail of a poster that had its QR-code or other machine-readable data previously scanned by a user of the client. Poster thumbnail 907 may be actuated to transfer a full size poster image file (e.g. 179, shown in FIG. 1a) from the portal server to the client, if server logic (e.g., 169, shown in FIG. 1a) viewing access policy-engine allows display of the poster image file. The poster image file may be part of a page (e.g., 173, shown in FIG. 1a), which may be displayed using a browser (e.g., 206, shown in FIG. 1a).

Access policy may include checks for distance from venue, time since scanning the poster QR-code, being a poster session portal member, conference session password, matching email host address with poster session host address, embargo date, etc. It will be appreciated that other checks may be included in the access policy logic.

Button 803 may be actuated to switch the mobile list interface 984 to be configured to allow the user of the client to scan a poster's QR-codes or other machine-readable data at a conference session as shown in FIG. 8.

It will be appreciated that embodiment of the mobile list interface 984 shown in FIG. 9 and described above is only an example of the range of possible GUI interfaces that may suitably be employed. Additionally, it will be appreciated that while the mobile list interface 984 is described as having various buttons to perform a variety of functions, other means of performing the functions are of course possible. For example, images, check boxes, text fields (e.g., to enter “view” or “display”), and anchor text may be used to perform these functions and other contemplated functions.

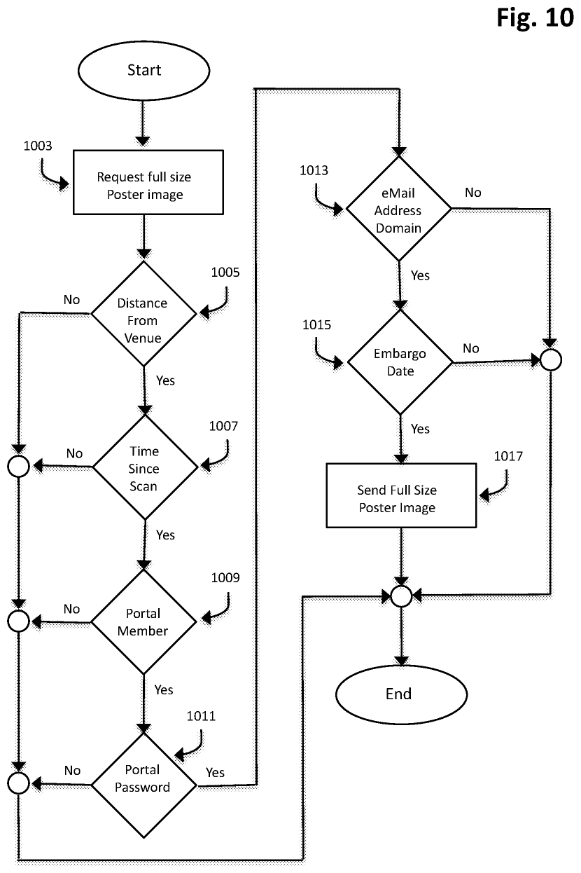

With reference now to FIG. 10, a high-level flowchart is shown, illustrating example, functionality (e.g. logical functions) of the poster management and delivery system 100. More particularly, in one example implementation, the flowchart of FIG. 10 may represent example method steps taken in operation of the poster management and delivery system 100, including steps taken both in the portal server 103, and in downloading (from the portal server 103 to the client 109) and operation of portal server 103 viewing access policy-engine.

As illustrated in FIG. 10, the method begins at block 1003, where a page 173 containing a mobile interface 184 was sent from the portal server 103 to the client 109 and the client requests a full size poster image file 179, accordance with some embodiments of this disclosure, the request is sent from the client 109 to the portal server 103 and the portal server 103 determines if the client 109 is authorized to request a full size poster image file prior to sending the poster image file 179 to the client 109. If it is determined that the client 109 is not authorized to request a poster (i.e. does not have appropriate access credentials), the portal server 103 may request further information from the client 109. Alternatively, if it is determined that the client 109 is authorized to request a poster (i.e. has appropriate access credentials), the portal server 103 will perform additional checks to determine if a poster is allowed to be download, as described in the steps below. It is understood that many means of authentication are possible. In general, the client must have an account and be logged in to the poster management and delivery system. In accordance with some embodiments of this disclosure, idle logins are auto-logged out.

In one example implementation, the interface 184 is configured to allow the user of the client 109 to display a list of posters that the user of the client 109 has previously scanned. The interface 184 allows the user of the client 109 to utilize input devices such as smart phone or tablet. It will be appreciated that the mobile interface 184, one example of which is shown and discussed further above in connection with FIG. 9, for example, may involve multiple pages 173 and/or may involve multiple hierarchical levels of menus, and may involve separate confirmation operations.

In the illustrated embodiment, poster thumbnail (e.g., 907, shown in FIG. 9) may be actuated to transfer a full size poster image file (e.g. 179, shown in FIG. 1a) from the portal server to the client, if server logic (e.g., 169, shown in FIG. 1a) viewing access policy-engine allows sending of the full size poster image file from the portal server to the client, as discussed below.

In block 1005, if the poster session portal viewing policy settings requires, a check is performed to determine the distance from the venue to the client location. If it is determined that the client distance is within the distance set in the poster session portal viewing policy settings, additional checks are performed in block 1007. Alternatively, if it is determined that the client distance is outside the distance set in the poster session portal viewing policy settings the portal server 103 may request further information from the client 109 and will not send a full size poster image file to the client.

In block 1007, if the poster session portal viewing policy settings requires, a check is performed to determine the time since to poster QR-code has been scanned. If it is determined that the time since scanned is within the viewing time limit set in the poster session portal viewing policy settings, additional checks are performed in block 1009. Alternatively, if it is determined that the time since scanned is outside the viewing time limit set in the poster session portal viewing policy settings the portal server 103 may request further information from the client 109 and will not send a full size poster image file to the client.

In block 1009, if the poster session portal viewing policy settings requires, a check is performed to determine if the client and the poster are members of the same poster session portal. If it is determined that the client and the poster are members of the same poster session portal, additional checks are performed in block 1011. Alternatively, if it is determined that the client and the poster are not members of the same poster session portal the portal server 103 may request further information from the client 109 and will not send a full size poster image file to the client.

In block 1011, if the poster session portal viewing policy settings requires, a page 173 containing a mobile interface 184 requesting the portal password is from the portal server to the client. If it is determined that the password matches the password set in the poster session portal viewing policy settings, additional checks are performed in block 1013. Alternatively, if it is determined that the password does not match the password set in the poster session portal viewing policy settings the portal server 103 may request further information from the client 109 and will not send a full size poster image file to the client.

In block 1013, if the poster session portal viewing policy settings requires, a check is performed to determine if the client and the poster session portal administrator eMail addresses share the same eMail domain. If it is determined that the client and the poster session portal administrator share the same eMail domain, additional checks are performed in block 1015. Alternatively, if it is determined that the client and the poster session portal administrator do not share the same eMail domain the portal server 103 may request further information from the client 109 and will not send a full size poster image file to the client.

In block 1015, if the poster session portal viewing policy settings requires, a check is performed to determine if the current date is past the embargo date of the poster. If it is determined that the current date is past the embargo date, block 1017 is executed. Alternatively, if it is determined that the current date is not past the embargo date the portal server 103 may request further information from the client 109 and will not send a full size poster image file to the client.

If block 1017 is reached, a full size poster image file (e.g. 179, shown in FIG. 1a) is sent from the portal server to the client. It will be appreciated that other checks may be included in the viewing access policy logic, as discussed above.

Although the server logic 169 discussed in connection with FIG. 10 and figures above may be embodied in software or code executed by general purpose hardware in accordance with some embodiments of this disclosure, as an alternative the server logic 169 may be embodied in whole or in part in dedicated hardware or a combination of software/general purpose hardware and dedicated hardware. If embodied in dedicated hardware, the server logic 169 may be implemented as a circuit or state machine that employs any one of or combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

In accordance with some embodiments of this disclosure, the flowcharts discussed in connection with FIG. 10 and figures above may show the architecture, functionality, and operation of an implementation of the server logic 169. If embodied in software, each block may represent a module, segment, or portion of code that comprises program instructions to implement that specified logical function(s). The program instructions may be embodied in the form of source code that comprises human-readable statements written in a programming language or machine code that comprises numerical instructions recognizable by suitable execution system such as a processor in a computer system or other system. The machine code may be converted from the source code, etc. If embodied in hardware, each block may represent a circuit or a number of interconnected circuits to implement the specified logical function(s).

Although the flowcharts show a specific order of execution, it is understood that the order of execution may differ from that which is depicted. For example, the order of execution of two or more blocks may be scrambled relative to the order shown. Also, two or more blocks shown in succession in the flowcharts may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention. Also, the flowcharts are relatively self-explanatory and are understood by those with ordinary skill in the art to the extent that software and/or hardware can be created by one with ordinary skill in the art to carry out the various logical functions as described herein.

Also, where the server logic 169 include software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the server logic 169 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It will be appreciated that the systems and methods described above may be varied in a variety of suitable ways. For example, the systems and methods described above have been described in terms of managing a poster session. However, it will be appreciated that the system and method may be utilized in managing other sorts of submitted documents and activities with and without associated deadlines.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention may have been described above with respect to only one or more of several illustrated embodiments, such feature may be combined with one or more other features of the other embodiments, as may be desired and advantageous for any given or particular application.

Accordingly, it is submitted that that scope of the patent should not be limited to the described embodiments but rather should be limited only by the spirit and scope of the following claims.

What is claimed is:

1. A system of management and delivery of research/scientific posters over acomputer network, comprising:
(a) a web application for creating a poster session portal, managing poster submissions, allowing presenters to submit posters, and searching a poster repository;
(b) a server that processes session portal creation requests, session management requests, and poster submission requests;
(c) a database for storing session portal information and poster meta-data;
(d) a searchable repository for storing and accessing research/scientific posters;
(e) a research/scientific poster labeling system with a viewing access policy-engine; and
(f) a mobile application for scanning a research/scientific poster's label and viewing scanned research/scientific posters.

2. The system of claim 1, wherein the research/scientific poster labeling system takes the form of a Quick Response (QR) code labeling system, and the research/scientific poster's label may include or correspond to a QR code.

3. A method of processing and managing posters associated with one or more conference sessions, comprising:
receiving, at an input of a portal server, a request from a client coupled to the portal server, the request relating to at least one function or operation of a poster management and delivery system;
in response to the request corresponding to a request to create a poster session portal associated with a conference session, sending a page containing an administrator portal creation interface from the portal server to the client;
receiving poster session portal definitions in the administrator portal creation interface;
transmitting poster session portal data indicative of the poster session portal definitions from the client to the portal server; and
processing the poster session portal data on the portal server to create the poster session portal, the poster session portal corresponding to a platform for poster submitters to submit poster data associated with posters.

4. The method of claim 3, further comprising:
in response to the request corresponding to a request to manage poster session portal join requests associated with the poster session portal, sending a page containing an administrator portal management interface from the portal server to the client;
managing the poster session portal join requests on the administrator portal management interface;
transmitting information associated with the management of the poster session portal join requests from the client to the portal server; and
storing the information associated with the management of the poster session portal join requests on a memory device associated with the portal server.

5. The method of claim 4, wherein managing the poster session portal join requests includes evaluating the poster session portal join requests based on one or more criterion, and accepting or rejecting the poster session portal join requests based on the evaluation.

6. The method of claim 5, wherein the criterion is set by an administrator of a poster session portal on the poster management and delivery system.

7. The method of claim 5, wherein the criterion includes at least one of email address and institution name.

8. The method of claim 5, further comprising: for the poster session portal join requests that are accepted, requesting additional information associated with posters associated with the accepted poster session portal join requests.

9. The method of claim 3, further comprising:
in response to the request corresponding to a request from the poster submitters to submit poster data, sending a page containing a poster submitter interface from the portal server to the client;
receiving at least a title and an abstract of a poster for submission in the poster submitter interface;
transmitting the title and the abstract of the poster from the client to the portal server; and
evaluating the title and the abstract of the poster on the portal server to determine if the title and abstract are acceptable.

10. The method of claim 9, wherein the title and the abstract are received from one or more input devices associated with the poster submitters.

11. The method of claim 9, wherein the title and the abstract are determined to be acceptable if the title and the abstract meet one or more criterion.

12. The method of claim 11, wherein the criterion is set by an administrator of a poster session portal on the poster management and delivery system.

13. The method of claim 10, further comprising:
in response to determining that the title and abstract are acceptable, requesting additional information from the client relating to the poster.

14. The method of claim 13, wherein the additional information includes at least one of: author of the poster, contact information of the author, research sponsor, research advisor, and embargo date.

15. The method of claim 13, further comprising:
receiving the additional information from the client;
transmitting the additional information from the client to the portal server;
processing the additional information on the portal server to determine if a satisfactory poster submission has been achieved; and
in response to determining that a satisfactory poster submission has been achieved, saving the title and the abstract of the poster, and the additional information relating to the poster, on a memory device associated with the portal server.

16. The method of claim 15, wherein the method further comprises: in response to determining that a satisfactory poster submission has been achieved, assigning a poster number to the poster, and/or sending one or more messages to the client relating to the poster submission.

17. The method of claim 15, wherein the title and the abstract of the poster, and the additional information relating to the poster, are saved as image files, and the method further comprises: transferring the image files from the portal server to an archive server for later access by one or more users of the poster management and delivery system.

18. The method of claim 17, wherein the one or more users include at least one of an administrator, a poster submitter, and a poster viewer.

19. The method of claim 3, further comprising:
in response to the request corresponding to a request from a poster searcher to search poster data, sending a page containing an archive server interface from the portal server to the client;
receiving one or more keywords relating to the search in the archive server interface;
providing the keywords to an archive server coupled to at least one of the portal server and the client;
searching a memory device associated with the archive server for poster data relating to the keywords; and
providing the poster data to the client.

20. The method of claim 19, wherein the poster data is provided in one more image files on the memory device.

21. The method of claim 1, further comprising:
in response to the request corresponding to a request from a poster viewer to view one or more posters, sending a page containing an interface capable of scanning machine-readable data from the portal server to the client;
scanning select machine-readable data associated with the one or more posters using the client; and
processing the select machine-readable data to view information about the one or more posters on the client.

22. The method of claim 21, wherein the select machine-readable data corresponds to a Quick Response (QR) code.
